(19) United States
(12) Patent Application Publication
(10) Pub. No.: US 2007/0047497 A1
(43) Pub. Date: Mar. 1, 2007

(54) INTER-PROCESSOR COMMUNICATION IN A MOBILE COMMUNICATION TERMINAL

(75) Inventors: Hyung Suk OH, Seoul (KR); Pil Gyun KANG, Gunpo-si, Gyeonggi-Do (KR)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: LG ELECTRONICS INC., Seoul (KR)

(21) Appl. No.: 11/467,837

(22) Filed: Aug. 28, 2006

(30) Foreign Application Priority Data
Aug. 26, 2005 (KR) 10-2005-0079044

(51) Int. Cl. H04B 7/216

(52) U.S. Cl. 370/335; 370/320; 370/342; 370/441

(57) ABSTRACT

A method for communicating a voice call between heterogeneous microprocessor modules is disclosed. In one example embodiment, a method for inter-processor communication in a mobile communication terminal equipped with first and second microprocessor modules includes the acts of: sending a first High-level Data Link Control (HDLC) message packet to the second microprocessor module; receiving the first HDLC message packet from the first microprocessor module; sending a second HDLC message packet to the first microprocessor module; and receiving the second HDLC message packet from the second microprocessor module.

### CROSS-REFERENCE TO RELATED APPLICATIONS

This application claims the benefit of Korean Patent Application No. 10-2005-0079044, filed on Aug. 26, 2005, which is hereby incorporated by reference in its entirety.

### BACKGROUND OF THE INVENTION

1. Field of the Invention

The present invention relates to a mobile communication terminal. More particularly, embodiments of the invention relate to methods for providing inter-processor communication in a mobile communication terminal equipped with two or more programmable devices.

2. Discussion of the Related Art

With the increasing demands of consumers and the increasing development of communication technologies, a variety of manufactured products having heterogeneous microprocessors for different functions are being widely developed. For example, a mobile communication terminal, such as a cellular telephone having personal digital assistant (PDA) capabilities, can be equipped with two different programmable devices, such as microprocessors, one for providing communication functions and the other for providing PDA functions.

Typically, mobile communication devices having two or more heterogeneous microprocessors use AT commands to communicate data between the processors. AT commands, also known as the Hayes command set, which can also be used to communicate with and configure modems, are generally used to transmit data using a “base 64” scheme. Base64 is a specific encoding/decoding scheme for converting between binary data and printable ASCII characters. Base64 divides data into four 6-bit units such that the data is represented by four 7-bit ASCII texts. Base64 can be used, for example, to transmit image or audio files via an E-mail.

In order to enable image and audio files to be transferred between platforms, base64 protocol converts binary data into ASCII characters. Each ASCII character is assigned one of 64 ASCII codes. When data is encoded using base64, the size of encoded data is about 33% larger than the original data. Hence, the approach is not very efficient. In addition, a transmitting microprocessor must include a base64 encoder functional component and a receiving microprocessor must include a base64 decoder component. As a result, communicating data between microprocessors using AT commands and a base64 scheme can be relatively complicated and time consuming.

### SUMMARY OF THE INVENTION

Accordingly, the present invention is directed to improved methods for providing inter-processor communication in a mobile communication terminal equipped with two or more microprocessors (or similar types of programmable devices).

In one example embodiment, a method for inter-processor communication in a mobile communication terminal equipped with first and second microprocessor modules is achieved via the exchange of High-level Data Link Control (HDLC) message packets. In one example application, the method could be used to communicate data associated with a voice call between a non-communication microprocessor module and a communication microprocessor module within a mobile communication terminal. To do so, the non-communication microprocessor module forwards a voice call request message packet to the communication microprocessor module. In response, the communication microprocessor module forwards a voice call response message packet that corresponds to the voice call request message packet back to the non-communication microprocessor module. The communication microprocessor module performs a voice call origination procedure and transmits a voice call request result report message packet to the non-communication microprocessor module; and transmitting, by the non-communication microprocessor module, a voice call request result report response message packet corresponding to the voice call request report message packet to the communication microprocessor module.

In another example embodiment, a method for communicating a voice call between a non-communication microprocessor module and a communication microprocessor module in a mobile communication terminal includes the acts of: transmitting, by the communication microprocessor module, a ring notification report request packet to the non-communication microprocessor module; receiving, at the non-communication microprocessor module, a call acceptance indication from a user; transmitting, by the non-communication microprocessor module, a call answer request packet to the communication microprocessor module; and transmitting, by the communication microprocessor module, a response of the call answer request packet to the non-communication microprocessor module.

In another example embodiment, a method for communicating a voice call between a non-communication microprocessor module and a communication microprocessor module in a mobile communication terminal includes the acts of: receiving, at the communication microprocessor module, a call termination signal from a second mobile communication terminal; transmitting, by the communication microprocessor module, a hang-up report request packet to the non-communication microprocessor module; and transmitting, by the non-communication microprocessor module, a response of hang-up report packet.

In another example embodiment, a method for communicating a voice call between a non-communication microprocessor module and a communication microprocessor module in a mobile communication terminal includes the acts of: receiving, at the communication microprocessor module, a call termination signal generated in response to user input on a user interface of the mobile communication terminal; transmitting, by the non-communication microprocessor module, a hang-up request packet to the communication microprocessor module; and transmitting, by the communication microprocessor module, a response of hang-up packet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a mobile communication terminal for use in a method for transmitting/receiving a voice call according to the present invention;

FIG. 2 is a flow chart illustrating a method for transmitting a voice call between heterogeneous microprocessor modules according to the present invention;

FIG. 3 is a flow chart illustrating a method for receiving a voice call between heterogeneous microprocessor modules according to the present invention; and

FIGS. 4 and 5 are flow charts illustrating methods for terminating a voice call between heterogeneous microprocessor modules according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

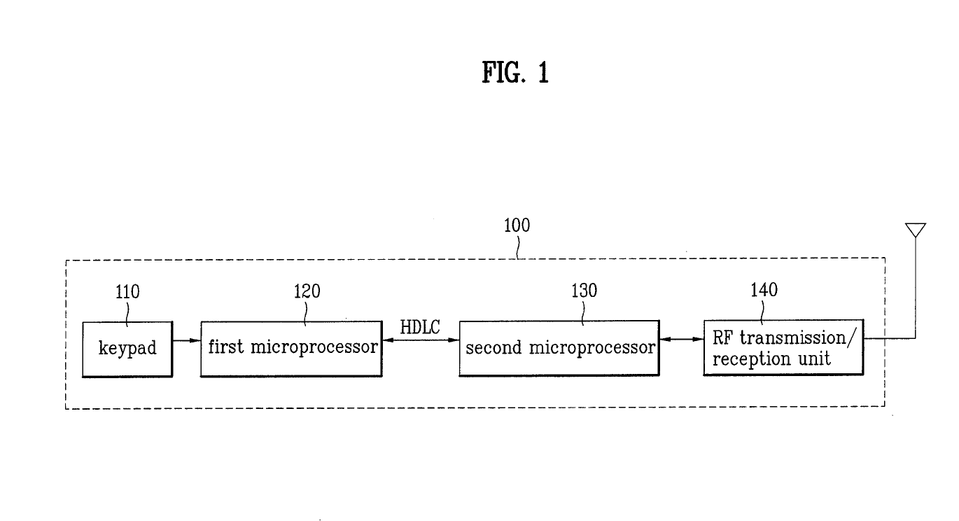

FIG. 1 is a block diagram illustrating a mobile communication terminal 100 for use in a method for transmitting/receiving a voice call according to embodiments of the present invention. In the example embodiment, the mobile communication terminal 100 includes first and second microprocessors 120 and 130, a keypad 110, and a Radio Frequency (RF) transmission/reception unit 140. The first microprocessor 120 communicates with the second microprocessor 130 according to a high-level data link control (HDLC) communication scheme. The keypad 10 generates electronic signals based on user input, and transmits the electronic signals conveying the user input to the first microprocessor 120. The RF transmission/reception unit 140 functions to transmit and/or receive RF signals based on control signals from the second microprocessor 130.

By way of example, the first microprocessor 120 may be configured as a non-communication microprocessor, such as a personal digital assistant (PDA) microprocessor. The second microprocessor 130 may be configured as a communication microprocessor, such as a code divisional multiple access (CDMA) microprocessor. The mobile communication device 100 having the first and second microprocessors 120 and 130 may be integrated into, for example, a personal digital assistant (PDA) wireless phone.

The first microprocessor 120 communicates with the second microprocessor 130 according to the HDLC communication scheme. The HDLC communication scheme acts as a predetermined control procedure to divide information composed of predetermined bits into transmission control units called frames. The frames are then transmitted using commands and responses contained in the control information portion of the frames.

For example, if an application program of a first processor desires to transmit data to an application program of a second processor, the first processor uses the HDLC communication scheme to control the size of the transmitted data to be less than a predetermined size, stores the reduced data in a packet, and transmits the packet including the reduced data. A transmission program of the HDLC communication scheme discards data of more than the predetermined size.

One example of an asynchronous HDLC frame format that can be used is shown in Table 1:

TABLE 1

| Field | Length | Description |
|---|---|---|
| Information | Variable | Message |
| Frame Check | 16 | CRC |
| Ending Flag | 8 | Ending Character |

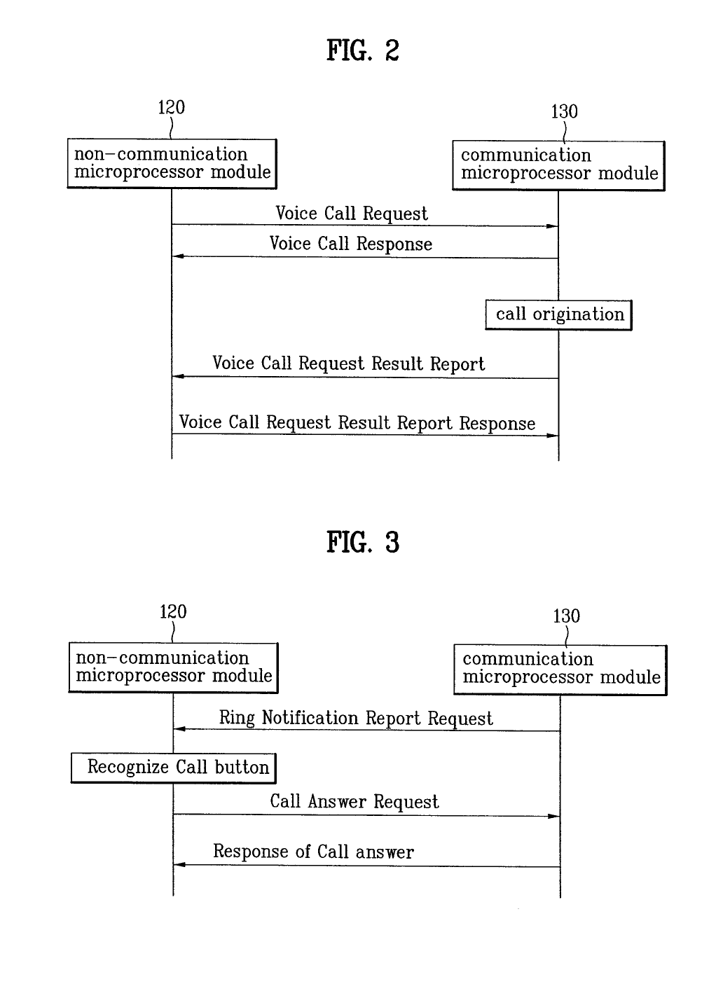

The “information” field contains messages for controlling a user interface of the non-communication microprocessor 120 and an interface of the communication microprocessor 130. The “information” field contains messages requested by user interface software of PDA phones and corresponding response messages, as disclosed in greater detail in connection with FIGS. 2-5.

The “frame check” field contains data used to detect any error in the transmission of the information field data. The data contained in the “frame check” field is a cyclic redundancy check (CRC) checksum that is generated by a standard CRC polynomial generator. A receiving microprocessor can perform a CRC calculation on the data contained in the “information” and “frame check” fields. The receiving microprocessor can then compare the result of the CRC calculation and the CRC checksum to validate the received data.

026 The “ending flag” field contains data that designates the end of the HDLC frame. The data in the “ending flag” field can be a predetermined binary sequence, such as “01111110(0X7E)”.

The first and second microprocessor modules 120 and 130 are configured to communicate using packets having similar structure. Each packet transmitted between the first and second microprocessor modules 120 and 130 corresponds to a predetermined command code.

FIG. 2 is a flow chart illustrating a method for transmitting a voice call between heterogeneous microprocessor modules according to the present invention. In order to request a voice call, the non-communication microprocessor module 120 first transmits a “voice call request” message packet in the information field of an HDLC frame formatted in the HDLC format shown in Table 1. The HDLC frame is transmitted to the communication microprocessor module 130. The “voice call request” message packet is shown in Table 2:

TABLE 2

| FIELD | LENGTH |
|---|---|
| CMD_CODE(53) | 1 |
| LENGTH | 1 |
| DIAL DIGIT | LENGTH(MAX 32) |
| SERVICE_OPTION | 1 |

The “CMD_CODE” field contains a message ID. The “length” field contains the length of a dial digit. The “dial digit” field contains a number digit having a maximum of 32 bytes. A value of “5” contained in the “SERVICE_OPTION” field denotes a voice signal of a Qualcomm Code Excited Linear Prediction (QCELP) of 8 kbps, a value of “6” denotes a voice signal of a QCELP of 13 kbps, and a value of “8” denotes a voice signal of an Enhanced Variable Rate Coder (EVRC).

The communication microprocessor module 130 next generates a success or failure response to the “voice call request” message and assembles the response into a “voice call response” message packet. The communication microprocessor module 130 then transmits the “voice call response” message packet to the non-communication microprocessor module 120.

The “voice call response” message packet is shown in Table 3:

TABLE 3

| Field | Length |
|---|---|
| CMD_CODE(53) | 1 |
| Result | 1 |

The “Result” field is set to “0” in a call-origination disable mode, and is set to “1” in a communication enable mode.

The communication microprocessor module 130 next performs a voice call origination procedure. Then, the communication microprocessor module 130 transmits a “voice call request result report” message packet indicating the final processing result of the voice call origination procedure to the non-communication microprocessor module 120. The “voice call request result report” message packet is shown in Table 4:

TABLE 4

| Field | Length |
|---|---|
| CMD_CODE(82) | 1 |
| Result | 1 |

The “Result” field is set to “0” in the case of the failure of a first call attempt signal, and is set to “1” in the case of the success of the first call attempt signal.

The non-communication microprocessor module 120 then transmits a “voice call request result report response” message packet to the communication microprocessor module 130. This message packet enables the communication microprocessor module 130 to determine whether the “voice call request result report” message packet was successfully received. The “voice call request result report response” message packet is shown in Table 5:

TABLE 5

| Field | Length |
|---|---|
| CMD_CODE(82) | 1 |
| Result | 1 |

The “result” field returns the same value as the “result” field transmitted in the “voice call response” message packet.

With reference now to FIG. 3, is a flow chart illustrating a method for receiving a voice call between heterogeneous microprocessor modules is disclosed. When the communication microprocessor module 130 of FIG. 3 receives a voice call, it firstly transmits a “ring notification report request” packet to the non-communication microprocessor module at intervals of, for example, 3 seconds. The “ring notification report request” packet is shown in Table 6:

TABLE 6

| FIELD | LENGTH |
|---|---|
| CMD_CODE(80) | 1 |
| TYPE | 1 |
| LENGTH | 2 |
| DATA | LENGTH(MAX 32) |

With reference to Table 6, if the “Type” field is set to “0” , it indicates a voice call. If the “Type” field is set to “1” , it indicates a data call. If the “Type” field is set to “2”, it indicates a fax call. The “Length” field designates the length of data in the “Data” field. The “Data” field has a predetermined size corresponding to a specific length, and includes information associated with another party's phone number.

In order to receive a call signal, the non-communication microprocessor module 120 transmits a “call answer request” packet, including incoming-call admission or denial information, to the communication microprocessor module 130. The “call answer request” packet is shown in Table 7:

TABLE 7

| Field | Length |
|---|---|
| CMD_CODE(63) | 1 |
| Class | 1 |
| Mode | 1 |

For example, a mobile communication terminal may be designed to receive a call signal if a user presses a “Call” button or predetermined key of the keypad. Alternatively, a mobile communication terminal may be designed to automatically receive a call signal if the user opens a flip or folder of the terminal or pushes up a slide of the terminal. In each situation, the mobile communication terminal may consider that the incoming call has been accepted.

If the user is using the mobile communication terminal to participate in a conference call or other important call in which the user does not wish to be disturbed, the mobile communication terminal may be configured to temporarily not receive any incoming calls. In this situation, the mobile communication terminal does not admit or accept an incoming call.

With reference to Table 7, if the “Class” field is set to “0”, it indicates a voice call. If the “Class” field is set to “1”, it indicates a data call. If the “Class” field is set to “2”, it indicates a fax call. In the meantime, if the “Mode” field is set to “0”, it indicates the denial of the incoming call. If the “Mode” field is set to “1”, it indicates the admission of the incoming call.

The communication microprocessor module 130 next transmits a response packet, which indicates whether the “call answer request” packet was successfully received, to the non-communication microprocessor module 120. The response is shown in Table 8:

TABLE 8

| Field | Length |
|---|---|
| CMD_CODE(63) | 1 |
| Class | 1 |
| Mode | 1 |

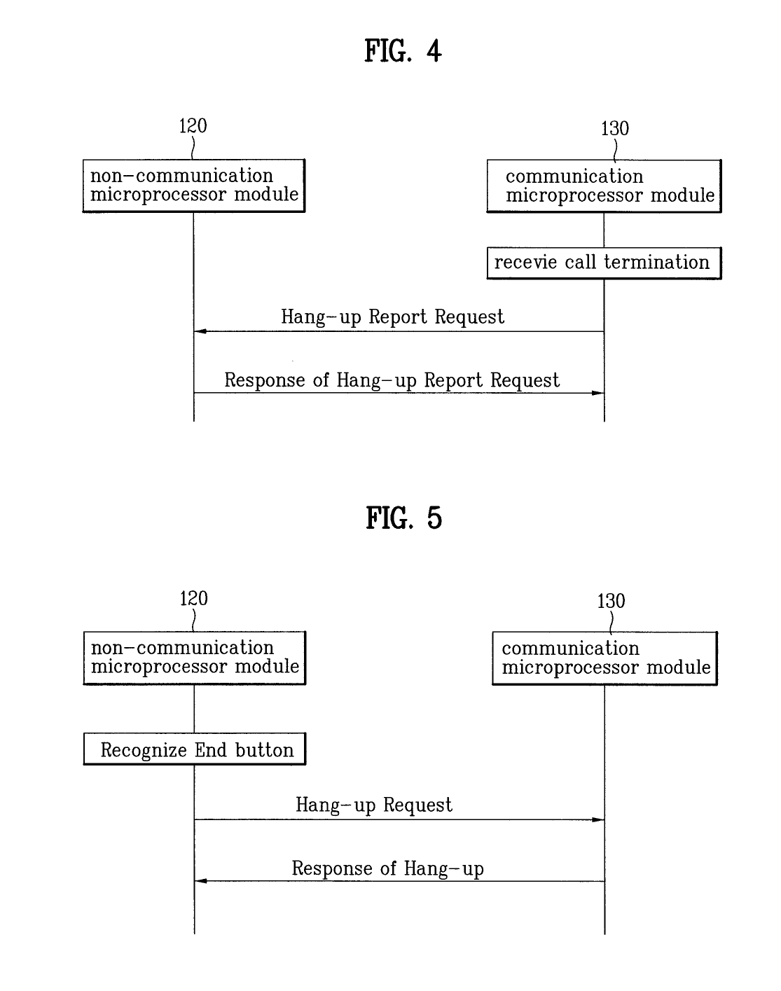

FIGS. 4 and 5 are flow charts illustrating a method for terminating a voice call between heterogeneous microprocessor modules according to the present invention. A call signal can be terminated according to a first hang-up case of FIG. 4 and a second hang-up case of FIG. 5.

The first hang-up case of FIG. 4 indicates that a call signal has been terminated by a mobile communication terminal. For example, an “End” button of a “Hang-up” button of the mobile communication terminal is pressed, the flip or folder of the transmission terminal is closed, or the slide of the transmission terminal is closed, such that the mobile communication terminal compulsorily terminates a call connection to another terminal. The communication microprocessor 130 transmits a “Hang-up Report Request” message indicating the call-connection termination to the non-communication microprocessor 120. In this case, the “Hang-up Report Request” message is show in Table 9:

TABLE 9

| Field | Length |
|---|---|
| CMD_CODE(84) | 1 |
| Status | 1 |

If the “Status” field is set to “0”, it indicates that the call signal has been terminated by an End button being pressed on another party's mobile communication terminal. If the “Status” field is set to “1”, it indicates that the call signal has been terminated in some other way.

The non-communication microprocessor module 120 transmits a “Response of Hang-up Report” packet corresponding to the above-mentioned “Hang-up Report” message. This packet is transmitted to the communication microprocessor module 120. The “Response of Hang-up Report” packet is shown in Table 10:

TABLE 10

| Field | Length |
|---|---|
| CMD_CODE(84) | 1 |
| Status | 1 |

The “Response of Hang-up Report” packet returns the same value as the “Status” field value transmitted from the Report.

Alternatively, the second hang-up case of FIG. 5 indicates that a call signal has been terminated by the user who directly closes the flip or slider of the mobile communication terminal.

The second hand-up case indicates that a call signal is terminated by the non-communication microprocessor module 120.

The non-communication microprocessor module 120 transmits a “Hang-up Request” message to the communication microprocessor module 130 using the packet shown in Table 11:

TABLE 11

| Field | Length |
|---|---|
| CMD_CODE(54) | 1 |

Upon receiving the Hang-up Request message from the non-communication microprocessor module 120, the communication microprocessor module 130 indicates whether the above-mentioned Hang-up Request message has been successfully processed using an HDLC-formatted packet shown in Table 12:

TABLE 12

| Field | Length |
|---|---|
| CMD_CODE(54) | 1 |
| Result | 1 |

With reference to Table 12, if the “Result” field is set to “0”, it indicates the hang-up failure. If the “Result” field is set to “1”, it indicates the hang-up success.

As apparent from the above description, a method for communicating a voice call between heterogeneous microprocessor modules according to the present invention uses an HDLC packet communication scheme, such that it can quickly perform a specific function without using an encoder or decoder, and the speed or accuracy of the serial communication is increased.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for inter-processor communication in a mobile communication terminal equipped with first and second microprocessor modules, the method comprising the step of:
establishing a call connection between the first and the second microprocessor module by exchanging at least one High-level Data Link Control (HDLC) message packet between the first and the second microprocessor modules.

2. The method according to claim 1, wherein the first microprocessor module is a non-communication microprocessor module and the second microprocessor module is a communication microprocessor module.

3. The method according to claim 2, wherein the first microprocessor module is a Personal Digital Assistant (PDA) processor module and the second microprocessor module is a Code Divisional Multiple Access (CDMA) processor module.

4. The method according to claim 1, wherein the first and second microprocessor modules are configured to communicate using packets having a substantially similar packet structure.

5. A method for communicating a voice call between a non-communication microprocessor module and a communication microprocessor module in a mobile communication terminal; the method comprising the acts of:
a) transmitting, by the non-communication microprocessor module, a voice call request message packet to the communication microprocessor module;
b) transmitting, by the communication microprocessor module, a voice call response message packet corresponding to the voice call request message packet to the non-communication microprocessor module;
c) performing, by the communication microprocessor module, a voice call origination procedure;
d) transmitting, by the communication microprocessor module, a voice call request result report message packet to the non-communication microprocessor module; and
e) transmitting, by the non-communication microprocessor module, a voice call request result report response message packet corresponding to the voice call request report message packet to the communication microprocessor module.

6. The method according to claim 5, wherein the non-communication microprocessor module is a Personal Digital Assistant (PDA) processor module and the communication microprocessor module is a Code Divisional Multiple Access (CDMA) processor module.

7. The method according to claim 5, wherein message packets are transmitted between the non-communication microprocessor module and the communication microprocessor module using a High-level Data Link Control (HDLC) communication scheme.

8. The method according to claim 7, wherein the non-communication microprocessor module and the communication microprocessor module are configured to communicate using packets having substantially similar structure.

9. A method for communicating a voice call between a non-communication microprocessor module and a communication microprocessor module in a mobile communication terminal, the method comprising the acts of:
a) transmitting, by the communication microprocessor module, a ring notification report request packet to the non-communication microprocessor module;
b) transmitting, by the non-communication microprocessor module, a call answer request packet to the communication microprocessor module;
c) receiving, at the non-communication microprocessor module, a call acceptance indication from a user; and
d) transmitting, by the communication microprocessor module, a response of the call answer request packet to the non-communication microprocessor module.

10. The method according to claim 9, wherein the non-communication microprocessor module is a Personal Digital Assistant (PDA) processor module and the communication microprocessor module is a Code Divisional Multiple Access (CDMA) processor module.

11. The method according to claim 9, wherein message packets are transmitted between the non-communication microprocessor module and the communication microprocessor module using a High-level Data Link Control (HDLC) communication scheme.

12. The method according to claim 11, wherein the non-communication microprocessor module and the communication microprocessor module are configured to communicate using packets having substantial similar structure.

13. A method for communicating a voice call between a non-communication microprocessor module and a communication microprocessor module in a mobile communication terminal, the method comprising the acts of:
receiving, at the communication microprocessor module, a call termination signal from a second mobile communication terminal;
transmitting, by the communication microprocessor module, a hang-up report request packet to the non-communication microprocessor module; and
transmitting, by the non-communication microprocessor module, a response of hang-up report packet.

14. The method according to claim 13, wherein the non-communication microprocessor module is a Personal Digital Assistant (PDA) microprocessor module and the communication microprocessor module is a Code Divisional Multiple Access (CDMA) microprocessor module.

15. The method according to claim 13, wherein message packets are transmitted between the non-communication microprocessor module and the communication microprocessor module using a High-level Data Link Control (HDLC) communication scheme.

16. The method according to claim 13, wherein the non-communication microprocessor module and the communication microprocessor module are configured to communicate using packets having similar structure.

17. A method for communicating a voice call between a non-communication microprocessor module and a communication microprocessor module in a mobile communication terminal, the method comprising the acts of:
receiving, at the communication microprocessor module, a call termination signal generated in response to user input on a user interface of the mobile communication terminal;
transmitting, by the non-communication microprocessor module, a hang-up request packet to the communication microprocessor module; and
transmitting, by the communication microprocessor module, a response of hang-up packet.

18. The method according to claim 17, wherein the non-communication microprocessor module is a Personal Digital Assistant (PDA) microprocessor module and the communication microprocessor module is a Code Divisional Multiple Access (CDMA) microprocessor module.

19. The method according to claim 17, wherein message packets are transmitted between the non-communication microprocessor module and the communication microprocessor module using a High-level Data Link Control (HDLC) communication scheme.

20. The method according to claim 17, wherein the non-communication microprocessor module and the communication microprocessor module are configured to communicate using packets having similar structure.
